(19) United States
(12) Patent Application Publication
(10) Pub. No.: US 2019/0057551 A1
(43) Pub. Date: Feb. 21, 2019

(54) SYSTEMS AND METHODS FOR COMBINED AUGMENTED AND VIRTUAL REALITY

(71) Applicant: JPMorgan Chase Bank, N.A., New York, NY (US)

(72) Inventors: Jeffrey Dean Mathwig, Worthington, OH (US); Eric C. Thinguldstad, New Albany, OH (US)

(21) Appl. No.: 15/999,145

(22) Filed: Aug. 17, 2018

Related U.S. Application Data
(60) Provisional application No. 62/546,908, filed on Aug. 17, 2017.

(51) Int. Cl. G06T 19/00; G02B 27/01; G06F 3/01; H04L 29/06

(52) U.S. Cl. CPC G06T 19/006; G02B 27/0172; G02B 2027/0138; H04L 67/38; G06F 3/011

(57) ABSTRACT

Systems and methods for combined augmented and virtual reality are disclosed. According to one embodiment, in an electronic device comprising at least one computer processor, a method for presenting combined augmented and virtual reality may include: (1) receiving, from an image capture device, physical data representing a plurality of physical characteristics for a physical environment; (2) receiving augmented reality data comprising at least one virtual characteristic for the physical environment; (3) generating at least one mesh representing the physical data and the augmented reality data; and (4) providing the at least one mesh as a virtual reality for the physical environment.

### RELATED APPLICATIONS

This application claims priority to U.S. Provisional Patent Application Ser. No. 62/546,908, filed Aug. 17, 2017, the disclosure of which is hereby incorporated, by reference, in its entirety.

### BACKGROUND OF THE INVENTION

### 1. Field of the Invention

The present disclosure generally relates to systems and methods for combined augmented and virtual reality.

### 2. Description of the Related Art

Augmented reality has been recently been used to superimpose computer-generated imagery onto a user's view of the real world. For example, using a camera in a mobile device, headset, or glasses, a user may presented with a display of his or her surroundings as captured by the camera that is seamlessly augmented with information about what is being seen. Augmented reality even lets users play games in which it appears that computer-generated objects are interacting with the real world.

### SUMMARY OF THE INVENTION

Systems and methods for combined augmented and virtual reality are disclosed. According to one embodiment, in an electronic device comprising at least one computer processor, a method for presenting combined augmented and virtual reality may include: (1) receiving, from an image capture device, physical data representing a plurality of physical characteristics for a physical environment; (2) receiving augmented reality data comprising at least one virtual characteristic for the physical environment; (3) generating at least one mesh representing the physical data and the augmented reality data; and (4) providing the at least one mesh as a virtual reality for the physical environment.

In one embodiment, the image capture device may include a headset.

In one embodiment, the physical characteristics may include a physical structure of the physical environment, equipment and furniture present in the physical environment, etc.

In one embodiment, virtual characteristic may include virtual equipment, virtual furniture, etc.

In one embodiment, the virtual reality for the physical environment may be provided to an image display device. The image display device may be at a location remote from the physical environment. In one embodiment, the image display device may be a wearable image display device.

In one embodiment, the virtual characteristic may include a virtual object. A change to the virtual object in the augmented reality data may be reflected in the virtual reality, and a change to the virtual object in the virtual reality may be reflected in the augmented reality data.

According to another embodiment, a system for presenting combined augmented and virtual reality may include an image capture device at a physical environment that captures physical data representing a plurality of physical characteristics for the physical environment; an augmented reality device that generates augmented reality data for the physical environment comprising at least one virtual characteristic for the physical environment; and an electronic device comprising at least one computer processor. The electronic device may perform the following: (1) receive the physical data for the physical environment from the image capture device; (2) receive the augmented reality data for the physical environment; (3) generate at least one mesh representing the plurality data and the augmented reality data; and (4) provide the at least one mesh as a virtual reality for the physical environment.

In one embodiment, the image capture device may include a headset.

In one embodiment, the physical characteristics may include a physical structure of the physical environment, equipment and furniture present in the physical environment, etc.

In one embodiment, the virtual characteristic may include virtual equipment, virtual furniture, etc.

In one embodiment, the virtual reality for the physical environment may be provided to an image display device. The image display device may be at a location remote from the physical environment. The image display device may be a wearable device.

In one embodiment, the virtual characteristic may include a virtual object. A change to the virtual object in the augmented reality data may be reflected in the virtual reality, and a change to the virtual object in the virtual reality may be reflected in the augmented reality data.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for combined augmented and virtual reality according to one embodiment;

FIG. 2 depicts a system for combined augmented and virtual reality according to one embodiment; and

FIG. 3 depicts a method for combined augmented and virtual reality is disclosed according to one embodiment.

### DETAILED DESCRIPTION OF PREFERRED EMBODIMENTS

Embodiments disclosed herein relate to systems and methods for combined augmented and virtual reality.

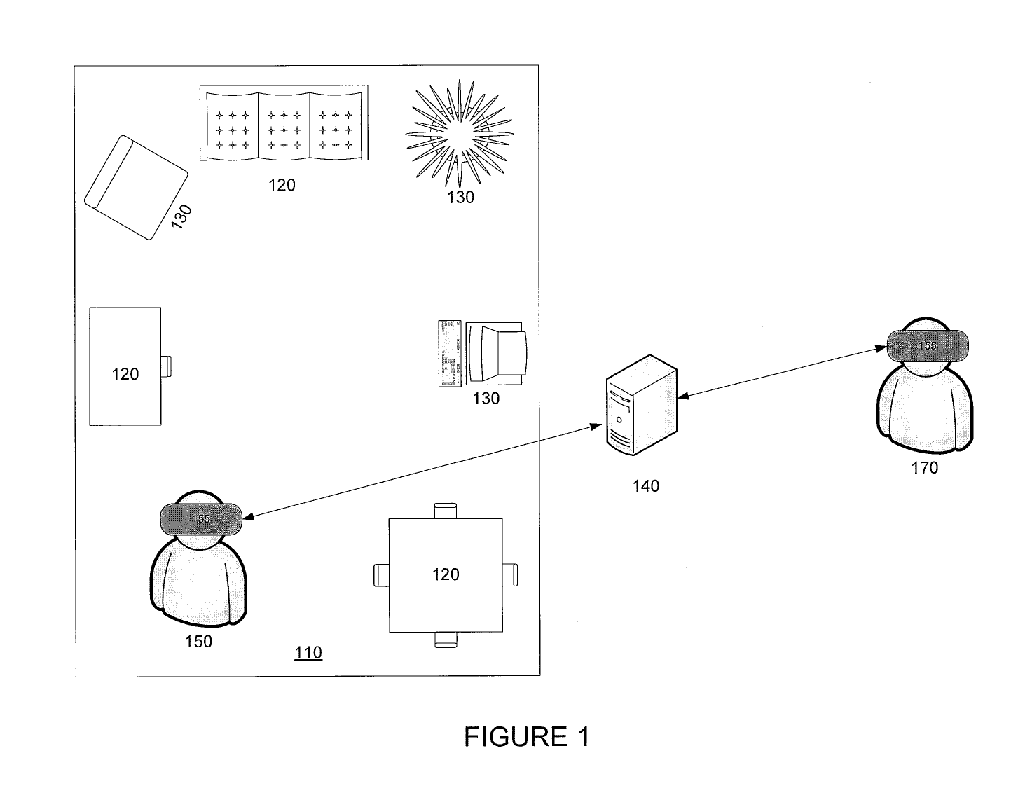

Referring to FIG. 1, a system for combined augmented and virtual reality is disclosed according to one embodiment. In FIG. 1, local user 150 in physical environment 110 may interact with physical objects 120 and virtual objects 130. Local user 150 may use an electronic display device 155, such as the Microsoft Hololens, a smart phone, smart glasses, etc., to display the augmented reality.

In one embodiment, virtual objects 130 may be generated by backend 140.

Although virtual objects 130 are not physically present in physical environment 110, they are presented to local user 150 as if they were physical objects. Local user 150 may manipulate virtual objects 130 as desired. For example, local user 150 may add, remove, move, change the properties of, etc. virtual objects 130 displayed in physical environment 110 as desired.

Although FIG. 1 depicts physical environment 110 as an office environment, it should be noted that the disclosure is not so limited. For example, physical environment 110 may be any suitable environment, including indoor environments, outdoor environments, large environments, small environments, mobile environments (e.g., vehicles), static environments, etc.

While local user 150 experiencing augmented reality may be able to physically and virtually interact with the augmented reality, remote user 170 (e.g., a user that is not present at physical environment 110 and cannot use augmented reality) will generally be limited to viewing a recording of the augmented reality captured by local user 150 (e.g., the user experiencing the augmented reality), and will have limited, if any, ability to interact with the captured augmented reality.

Embodiments disclosed herein are directed to systems and methods for combined augmented and virtual reality. In one embodiment, a virtual reality may be created from the augmented reality, so that remote user 170 may experience the augmented reality as a virtual reality.

In embodiments, either the local user or the remote user may manipulate virtual objects in their respective spaces, and the manipulations may be reflected in the other space. For example, when the remote user manipulates a virtual object in the virtual reality, the manipulation is reflected to the local user in the augmented reality, and vice-versa. The remote user and the local user may collaborate to manipulate virtual objects.

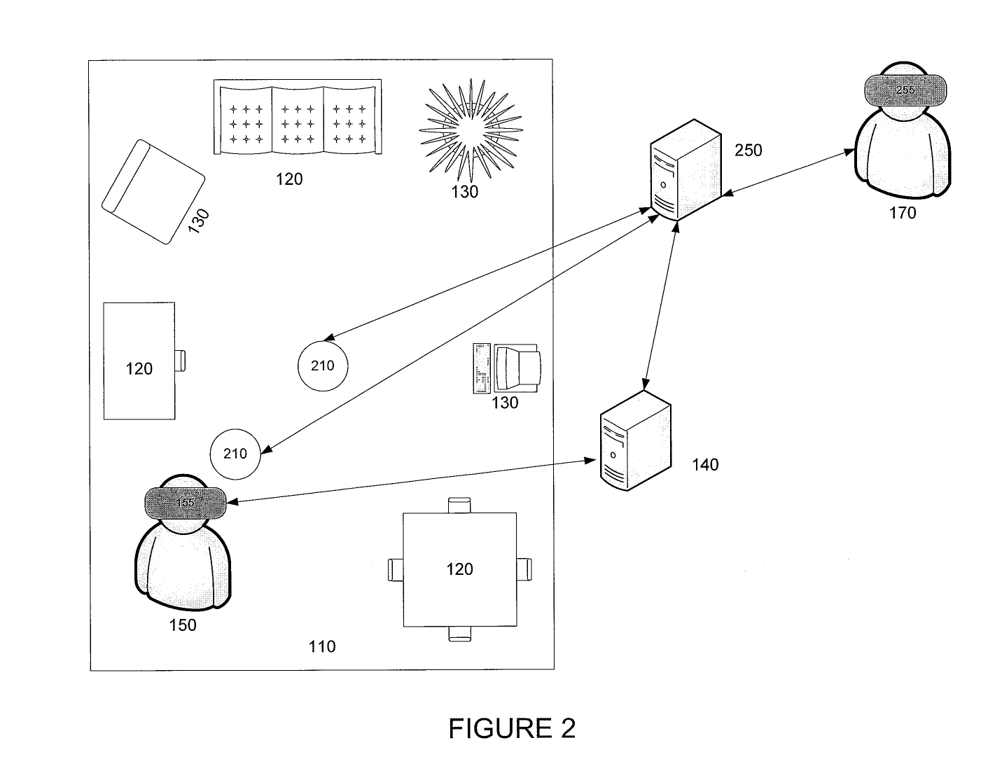

Referring to FIG. 2, server 250 may communicate with one or more camera or capture device 260 in order to capture the physical characteristics of surrounding 110. In one embodiment, the augmented reality may be generated and/or controlled by server 140, and displayed by electronic device 155 that may be worn by local user 150, or a separate computing device that is in communication with a presentation device worn or used by local user 150.

Server 250 may receive the data captured by cameras 260. Server 260 may also receive the computer-generated virtual objects from electronic device 155, or from server 140. Server 250 may generate meshes, and may combine them into a virtual reality that may be delivered to electronic device 255 that may be worn by remove user 170, or a separate computing device that is in communication with a presentation device worn or used by local user 170. Thus, remote user 170 may be presented with a combined virtual reality that includes both the augmented reality presented to local user 150, as well as the virtual reality for the physical elements in physical environment 110.

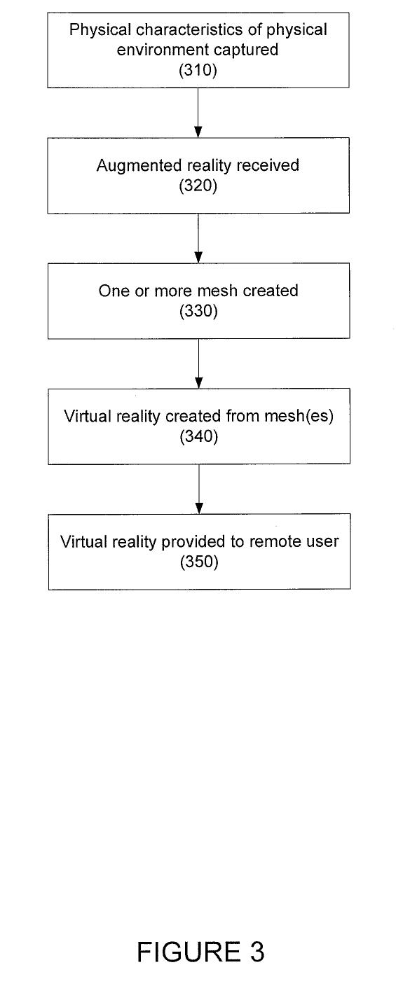

Referring to FIG. 3, a method for combined augmented and virtual reality is disclosed according to one embodiment.

In one embodiment, in step 310, the physical characteristics for a physical environment (e.g., walls, floors, ceilings, doors, furniture, equipment, etc.) may first be captured by the local user using one or more cameras worn or used by the local user. In another embodiment, the physical characteristics may be captured using one or more camera that may be provided in the surroundings. In another embodiment, a combination of worn/used cameras and surrounding cameras may be used as is necessary and/or desired.

In step 320, the augmented reality (e.g., computer-generated imagery such as furniture, pictures, etc.) that is being generated and displayed for the local user may be received by a server. In one embodiment, the augmented reality may be received from the server that is generating the augmented reality, from the headset of other device that is presenting the augmented reality to the local user, etc.

Next, in step 330, one or more “mesh” may be created based on the captured physical characteristics and the augmented reality. In one embodiment, one mesh may be created for the physical characteristics, and a second mesh may be created for the virtual surroundings.

Next, in step 340, a virtual reality environment may be generated from the meshes that may allow a remote user to virtually interact with the augmented reality. Then, in step 350, the remote user may be presented with the virtual reality using a presentation device, such as the Microsoft Hololens, or any other suitable device.

In one embodiment, the remote user may manipulate virtual objects in virtual reality and those manipulations may be reflected in the augmented reality presented the local user. For example, the remote user may “move” a virtual object, and the movement of the virtual object may be presented to the local user in real-time, or substantially in real-time.

In one embodiment, the remote user may have limited interactions with physical objects. For example, the remote user may not be able to take any action with a physical object that the local user could not take.

In one embodiment, augmented objects, such as furniture, wall coverings, equipment (e.g., ATMs, kiosks, cabinets, etc.), and for outdoor environments, objects such as grass, flowers, houses, etc. may be added and/or manipulated by either the local user (i.e., the user in the augmented reality space) or the remote user (i.e., the user in the combined augmented-virtual reality space). Either or both users may manipulate the augmented objects (e.g., add, remove, move, re-size, change the properties of, etc.), and the other user may see the manipulation of the virtual object.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, objective C, Swift, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for presenting combined augmented and virtual reality, comprising:
in an electronic device comprising at least one computer processor:
receiving, from an image capture device, physical data representing a plurality of physical characteristics for a physical environment;
receiving augmented reality data comprising at least one virtual characteristic for the physical environment;
generating at least one mesh representing the physical data and the augmented reality data; and
providing the at least one mesh as a virtual reality for the physical environment.

2. The method of claim 1, wherein the image capture device comprises a headset.

3. The method of claim 1, wherein the physical characteristics comprise a physical structure of the physical environment.

4. The method of claim 1, wherein the physical characteristics comprise equipment and furniture present in the physical environment.

5. The method of claim 1, wherein the virtual characteristic comprises virtual equipment.

6. The method of claim 1, wherein the virtual characteristic comprises virtual furniture.

7. The method of claim 1, wherein the virtual reality for the physical environment is provided to an image display device.

8. The method of claim 7, wherein the image display device is at a location remote from the physical environment.

9. The method of claim 7, wherein the image display device is a wearable image display device.

10. The method of claim 1, wherein the virtual characteristic comprises a virtual object; wherein
an augmented reality change to the virtual object in the augmented reality data is reflected in the virtual reality; and
a virtual reality change to the virtual object in the virtual reality is reflected in the augmented reality data.

11. A system for presenting combined augmented and virtual reality, comprising:
an image capture device at a physical environment that captures physical data representing a plurality of physical characteristics for the physical environment;
an augmented reality device that generates augmented reality data for the physical environment comprising at least one virtual characteristic for the physical environment; and
an electronic device comprising at least one computer processor that performs the following:
receives the physical data for the physical environment from the image capture device;
receives the augmented reality data for the physical environment;
generates at least one mesh representing the plurality data and the augmented reality data; and
provides the at least one mesh as a virtual reality for the physical environment.

12. The system of claim 11, wherein the image capture device comprises a headset.

13. The system of claim 11, wherein the physical characteristics comprise a physical structure of the physical environment.

14. The system of claim 12, wherein the physical characteristics comprise equipment and furniture present in the physical environment.

15. The system of claim 11, wherein the virtual characteristic comprises virtual equipment.

16. The system of claim 11, wherein the virtual characteristic comprises virtual furniture.

17. The system of claim 11, wherein the virtual reality for the physical environment is provided to an image display device.

18. The system of claim 17, wherein the image display device is at a location remote from the physical environment.

19. The system of claim 17, wherein the image display device is a wearable image display device.

20. The system of claim 1, wherein the virtual characteristic comprises a virtual object; wherein
an augmented reality change to the virtual object in the augmented reality data is reflected in the virtual reality; and
a virtual reality change to the virtual object in the virtual reality is reflected in the augmented reality data.
